(19) United States
(12) Patent Application Publication
(10) Pub. No.: US 2024/0054323 A1
(43) Pub. Date: Feb. 15, 2024

(54) MACHINE LEARNING FOR INDIVIDUAL MORAL DECISION-MAKING

(71) Applicants: Ge Wang, Loudonville, NY (US); Christopher Wiedeman, Troy, NY (US); Uwe Kruger, Callston Lake, NY (US)

(72) Inventors: Ge Wang, Loudonville, NY (US); Christopher Wiedeman, Troy, NY (US); Uwe Kruger, Callston Lake, NY (US)

(73) Assignee: Rensselaer Polytechnic Institute, Troy, NY (US)

(21) Appl. No.: 18/278,496

(22) PCT Filed: Feb. 28, 2022
(86) PCT No.: PCT/US22/18102

§ 371 Date: Aug. 23, 2023

Related U.S. Application Data
(60) Provisional application No. 63/154,304, filed on Feb. 26, 2021.

(51) Int. Cl. G06N 3/045; G06N 3/08

(52) U.S. Cl. CPC G06N 3/045; G06N 3/08

(57) ABSTRACT

A decision network for moral decision-making includes a trained group artificial neural network (ANN), a trained individual ANN, and a fusion block. The trained group ANN is configured to receive a selected input vector and to produce an estimated en group output based, at least in part, on the selected input vector. The trained group ANN is trained based, at least in part, on group training data including a plurality of group input vectors and corresponding training group outputs. Each group input vector includes a plurality of scenario parameters. The trained individual ANN is configured to receive the selected input vector and to produce an estimated individual output based, at least in part, on the selected input vector. The trained individual ANN is trained after the trained group ANN is trained.

### CROSS REFERENCE TO RELATED APPLICATION(S)

This application claims the benefit of U.S. Provisional Application No. 63/154,304, filed Feb. 26, 2021, which is incorporated by reference as if disclosed herein in its entirety.

### FIELD

The present disclosure relates to machine learning, in particular to, machine learning for individual moral decision-making.

### BACKGROUND

The rise of artificial intelligence (AI)-based automation is rapidly creating an interest in equipping the technology with ethical (e.g., moral) decision-making capabilities. Moral decision-making is often considered subjective and nebulous: even in simple instances, where a morally correct decision seems self-evident, there is not a mathematical proof or procedure that can objectively justify a decision as superior over others. Still, humanity is constantly faced with moral dilemmas, forced to weigh the consequences of certain actions with no quantitative guidance. The increasing use of AI may require ethical decision-making from machines.

### SUMMARY

In some embodiments, there is provided a decision network for moral decision-making. The decision network for moral decision-making includes a trained group artificial neural network (ANN), a trained individual ANN, and a fusion block. The trained group ANN is configured to receive a selected input vector and to produce an estimated group output based, at least in part, on the selected input vector. The trained group ANN is trained based, at least in part, on group training data including a plurality of group input vectors and corresponding training group outputs. Each group input vector includes a plurality of scenario parameters. The trained individual ANN is configured to receive the selected input vector and to produce an estimated individual output based, at least in part, on the selected input vector. The trained individual ANN is trained after the trained group ANN is trained. The trained individual ANN is trained based, at least in part, on individual training data comprising a plurality of individual input vectors and corresponding training individual outputs. Each individual input vector includes the plurality of scenario parameters. Each training individual output corresponds to a same individual. The fusion block is coupled to the trained group ANN and the trained individual ANN, and configured to receive the estimated group output and the estimated individual output, and to produce a decision output based, at least in part, on the estimated group output and based, at least in part, on the estimated individual output.

In some embodiments of the decision network, each ANN corresponds to a dense encoder network.

In some embodiments of the decision network, each ANN includes a first stage, a second stage and a third stage. The first stage and the second stage each includes a respective first layer, a respective second layer, and a respective third layer. Each first layer corresponds to a dense layer. Each second layer corresponds to a rectified linear unit (ReLU). Each third layer corresponds to a batch normalization layer. The third stage includes a dense layer, and an activation layer.

In some embodiments of the decision network, each ANN includes a first stage, a second stage and a third stage. The first stage and the second stage each includes a respective first layer, a respective second layer, and a respective third layer. Each first layer corresponds to a dense layer. Each second layer corresponds to a dropout layer. Each third layer corresponds to a rectified linear unit (ReLU). The third stage includes a dense layer, and an activation layer.

In some embodiments of the decision network, each scenario parameter is selected from the group including a plurality of categories comprising sex, age group, pregnant, fat, fit, working, medical, homeless, criminal, human, non-human, passenger, law-abiding, law violating, and/or a combination thereof, and number of characters in each category.

In some embodiments of the decision network, the decision output is selected from the group including intervene or not intervene.

In some embodiments, there is provided a method for training a decision network for individual moral decision-making. The method includes adjusting, by a training module, at least one group network parameter of a group artificial neural network (ANN) based, at least in part, on group training data. The group training data includes a plurality of training group data pairs. Each training group data pair includes a training group input vector and a corresponding group output. Each training group input vector includes a plurality of scenario parameters. The method further includes adjusting, by the training module, at least one individual network parameter of an individual ANN based, at least in part, on individual training data. The individual training data includes a plurality of individual training data pairs. Each training individual data pair includes a training individual input vector and a corresponding individual output. Each training individual input vector includes a plurality of scenario parameters. The group network parameters are fixed during the training of the individual ANN.

In some embodiments, the method further includes adjusting, by the training module, a fusion block parameter. The fusion block is configured to receive an estimated group output from the group ANN and an estimated individual output from the individual ANN, and to produce a decision output. The fusion block is coupled to the group ANN and the individual ANN.

In some embodiments of the method, each ANN corresponds to a dense encoder network.

In some embodiments of the method, each ANN includes a first stage, a second stage and a third stage. The first stage and the second stage each includes a respective first layer, a respective second layer, and a respective third layer. Each first layer corresponds to a dense layer. Each second layer corresponds to a rectified linear unit (ReLU). Each third layer corresponds to a batch normalization layer. The third stage includes a dense layer, and an activation layer.

In some embodiments of the method, each ANN includes a first stage, a second stage and a third stage. The first stage and the second stage each includes a respective first layer, a respective second layer, and a respective third layer. Each first layer corresponds to a dense layer. Each second layer corresponds to a dropout layer. Each third layer corresponds to a rectified linear unit (ReLU). The third stage includes a dense layer, and an activation layer.

In some embodiments of the method, each scenario parameter is selected from the group including a plurality of categories comprising sex, age group, pregnant, fat, fit, working, medical, homeless, criminal, human, non-human, passenger, law-abiding, law violating, and/or a combination thereof, and number of characters in each category.

In some embodiments of the method, the decision output is selected from the group including intervene or not intervene.

In some embodiments, there is provided a computer readable storage device having stored thereon instructions that when executed by one or more processors result in the following operations including: any embodiment of the method.

In some embodiments, there is provided a decision system for moral decision-making. The decision system includes a computing device, and a decision network for moral decision-making. The computing device includes a processor, a memory, an input/output circuitry, and a data store. The decision network for moral decision-making includes a trained group artificial neural network (ANN), a trained individual ANN, and a fusion block. The trained group ANN is configured to receive a selected input vector and to produce an estimated group output based, at least in part, on the selected input vector. The trained group ANN is trained based, at least in part, on group training data including a plurality of group input vectors and corresponding training group outputs. Each group input vector includes a plurality of scenario parameters. The trained individual ANN is configured to receive the selected input vector and to produce an estimated individual output based, at least in part, on the selected input vector. The trained individual ANN is trained after the trained group ANN is trained. The trained individual ANN is trained based, at least in part, on individual training data comprising a plurality of individual input vectors and corresponding training individual outputs. Each individual input vector includes the plurality of scenario parameters. Each training individual output corresponds to a same individual. The fusion block is coupled to the trained group ANN and the trained individual ANN, and configured to receive the estimated group output and the estimated individual output, and to produce a decision output based, at least in part, on the estimated group output and based, at least in part, on the estimated individual output.

In some embodiments of the decision system, each ANN corresponds to a dense encoder network.

In some embodiments of the decision system, each ANN includes a first stage, a second stage and a third stage. The first stage and the second stage each includes a respective first layer, a respective second layer, and a respective third layer. Each first layer corresponds to a dense layer. Each second layer corresponds to a rectified linear unit (ReLU). Each third layer corresponds to a batch normalization layer. The third stage includes a dense layer, and an activation layer.

In some embodiments of the decision system, each ANN includes a first stage, a second stage and a third stage. The first stage and the second stage each includes a respective first layer, a respective second layer, and a respective third layer. Each first layer corresponds to a dense layer. Each second layer corresponds to a dropout layer. Each third layer corresponds to a rectified linear unit (ReLU). The third stage includes a dense layer, and an activation layer.

In some embodiments of the decision system, each scenario parameter is selected from the group including a plurality of categories comprising sex, age group, pregnant, fat, fit, working, medical, homeless, criminal, human, non-human, passenger, law-abiding, law violating, and/or a combination thereof, and number of characters in each category; and the decision output is selected from the group including intervene or not intervene.

In some embodiments, the decision system further includes a decision module configured to receive input data including the selected input vector, and to manage operation of decision network.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a decision system for moral decision-making, according to several embodiments of the present disclosure;

FIG. 2 illustrates a functional block diagram of an example artificial neural network (ANN) architecture, according to an embodiment of the present disclosure; and

FIG. 3 is a flowchart of operations for moral decision-making, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Applications of machine ethical (i.e., moral) decision-making may include, but are not limited to, autonomous vehicles, health care, etc. Successful development of ethical decision-making in these applications may be based, at least in part, on suitable models for these decisions. As used herein, “ethical” and “moral” are used interchangeably.

An example of an AI ethical decision-making scenario is an imminent crash of an autonomous vehicle. In a hypothetical scenario, an autonomous vehicle with a catastrophic brake failure must decide between not changing trajectory and killing a group of pedestrians or changing trajectory and killing the vehicle's passengers. In this scenario, there is no other option and the two options may be classified as intervene (i.e., change trajectory) or not intervene (i.e., not change trajectory). Examples of this scenario have been investigated in The Moral Machine experiment (http://moralmachine.mit.edu/). The Moral Machine experiment surveyed thousands of people worldwide for their preferences in autonomous vehicle ethical dilemmas. In any given instance, a participant would be presented with an unwinnable scenario, in which two groups of people existed, but only one group could be saved. The survey aggregated answers based on geographic region and was configured to evaluate the moral value that societies generally placed on a range of abstract human characteristics (i.e., dimensions) including, for example, age, social status, law adherence, and gender. Thus, input data included a plurality of scenario parameters and their associated values, with at least some scenario parameters corresponding to human characteristics, and the experiment output was a binary decision (i.e., intervene, not intervene). The input data and experiment decision output may then be used to develop a model, configured to receive new input data associated with an ethical dilemma and to make a moral decision. For example, the moral decision making may be modeled as a hierarchical Bayesian model. It may be appreciated that a hierarchical Bayesian model may be generated based, at least in part, on an assumption of a normal underlying probability distribution in the data. This assumption may or may not be appropriate.

Generally, this disclosure relates to machine learning for moral decision-making. A method, apparatus and/or system may be configured to model a moral decision without assuming an underlying probability distribution in the data. In an embodiment, according to the present disclosure, a moral decision-making model may include a deep neural network configured to predict a morality-based decision of an individual using group training data for a group that includes a plurality of individuals and individual training data for a selected individual. The training data may correspond to random variables from a multivariate distribution, where the mean distribution may be understood to represent values of the group, and variances represent the in-group differences in beliefs or value systems. In an embodiment, a decision network, that includes at least one neural network, may be configured to learn a set of characteristics of a cultural group (from relatively abundant training data) and estimate variable values that an individual belonging to the cultural group may have. The estimated variable values may be represented in a latent space and may then be fused together to predict a selected individual's decision in a moral dilemma.

In an embodiment, a decision system, according to the present disclosure, may include a decision network that includes a group artificial neural network (ANN), an individual ANN and a fusion block. The group ANN and the individual ANN may both be configured to receive an input vector that includes a plurality of scenario parameters. The group ANN may be configured to generate a group output based, at least in part, on the received input data. The group ANN may be configured to learn and represent abstract values in a latent space. The individual ANN may be configured to generate an individual output based, at least in part, on the received input data. The fusion block, that may include concatenation, addition and/or multiplication, may be configured to provide a decision output based, at least in part on the group output and based, at least in part, on the individual output. The outputs may be generated without assumptions regarding probability distribution(s) of the underlying data.

In operation, initially, the group ANN may be trained to predict moral decisions by assessing a selected group of individuals that includes at least one member. The members of the selected group may share one or more common group member characteristics. The group ANN may be trained using training data regarding ethical decisions of a plurality of members of the group. The group ANN may then be trained with a relatively large amount of data. Once the group ANN is trained, the group ANN parameters and configuration may be frozen, and the group ANN may be included in the decision network, as described herein.

The individual ANN may then be trained using training data regarding ethical decisions of a selected individual. The behavior of the individual may be represented by the individual ANN. The individual ANN is configured to have a similar structure to the group ANN but trained with relatively limited data pertaining to only the selected individual. In one nonlimiting example, a Wasserstein generative adversarial network (WGAN) framework may be utilized to train the individual ANN. The decision network may be configured to take abstract values of the group, represented by the trained group ANN, and fuse these values with learned behavior of an individual, represented by the trained individual ANN, to predict an outcome.

A deep learning model (e.g., decision network), according to the present disclosure, may thus be configured to estimate abstract moral values of an individual. For example, a method, device, and/or system may be configured to estimate a moral decision based, at least in part, on the Moral Machine experiment data. In another example, a method, device and/or system, according to the present disclosure, may be applied to medical moral decision-making, within the scope of the present disclosure.

It is contemplated that, by broadly learning the moral values of a cultural group, and then observing a few decisions of a selected individual belonging to this group, a deep neural network may be configured to predict the moral decisions of the selected individual in new scenarios. It is contemplated that an accurate deep learning model for moral decision making may then be useful for embedding morality in future AI systems.

In an embodiment, there is provided a decision network for moral decision-making. The decision network for moral decision-making includes a trained group artificial neural network (ANN), a trained individual ANN, and a fusion block. The trained group ANN is configured to receive a selected input vector and to produce an estimated group output based, at least in part, on the selected input vector. The trained group ANN is trained based, at least in part, on group training data including a plurality of group input vectors and corresponding training group outputs. Each group input vector includes a plurality of scenario parameters. The trained individual ANN is configured to receive the selected input vector and to produce an estimated individual output based, at least in part, on the selected input vector. The trained individual ANN is trained after the trained group ANN is trained. The trained individual ANN is trained based, at least in part, on individual training data comprising a plurality of individual input vectors and corresponding training individual outputs. Each individual input vector includes the plurality of scenario parameters. Each training individual output corresponds to a same individual. The fusion block is coupled to the trained group ANN and the trained individual ANN, and configured to receive the estimated group output and the estimated individual output, and to produce a decision output based, at least in part, on the estimated group output and based, at least in part, on the estimated individual output.

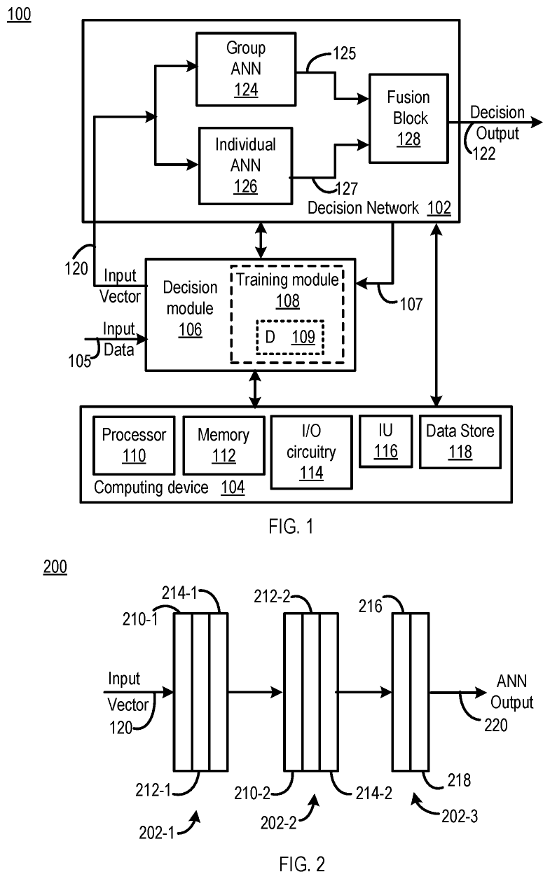

FIG. 1 illustrates a functional block diagram of a decision system 100 for moral decision-making, according to several embodiments of the present disclosure. Decision system 100 includes a decision network 102, a computing device 104, and a decision module 106. In some embodiments, decision system 100, e.g., decision module 106, may include a training module 108. In some embodiments, training module 106 may include a discriminator (D) 109. Decision network 102 and/or decision module 106 may be coupled to or included in computing device 104. The decision network 102 is configured to receive an input vector 120 and to provide as output a decision output 122, as will be described in more detail below.

Decision network 102 includes a group artificial neural network (ANN) 124, an individual ANN 126 and a fusion block 128. Group ANN 124 and/or individual ANN 126 may include, but are not limited to, a deep ANN, a convolutional neural network (CNN), a deep CNN, a multilayer perceptron (MLP), etc. In an embodiment, group ANN 124 and/or individual ANN 126 may each correspond to a respective dense encoder. The group ANN 124 and the individual ANN 126 are configured to receive the input vector 120. The group ANN 124 is configured to produce a group output 125. The individual ANN 126 is configured to produce an individual output 127. The fusion block 128 is configured to receive the group output 125 and the individual output 127, and to produce the decision output 122.

Computing device 104 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 104 includes a processor 110, a memory 112, input/output (I/O) circuitry 114, a user interface (UI) 116, and data store 118.

Processor 110 is configured to perform operations of decision network 102 and/or decision module 106. Memory 112 may be configured to store data associated with decision network 102 and/or decision module 106. I/O circuitry 114 may be configured to provide wired and/or wireless communication functionality for decision system 100. For example, I/O circuitry 114 may be configured to receive input data 105 (e.g., input vector and/or training data) and to provide decision output 122. UI 116 may include a user input device (e.g., keyboard, mouse, microphone, touch sensitive display, etc.) and/or a user output device, e.g., a display. Data store 118 may be configured to store one or more of input data 105, input vector 120, group output 125, individual output 127, decision output 122, network parameters associated with group ANN 124 and/or individual ANN 126, and data associated with decision module 106 and/or training module 108. Data associated with training module 108 may include, for example, training data, as described herein.

FIG. 2 illustrates a functional block diagram of an example artificial neural network (ANN) architecture 200, according to an embodiment of the present disclosure. In one nonlimiting example, ANN 200 may correspond to a dense encoder. ANN 200 is configured to receive input vector 120 and to provide as output ANN output 220. Group ANN 124 and/or individual ANN 126 may correspond to ANN architecture 200. ANN output 220 may thus correspond to group output 125 or individual output 127.

Generally, ANN 200 includes three stages 202-1, 202-2, 202-3, and each stage includes at least one layer. A first stage 202-1 includes a first layer 210-1, a second layer 212-1 and a third layer 214-1. A second stage 202-2 includes a first layer 210-2, a second layer 212-2 and a third layer 214-2. In one example, each first layer 210-1, 210-2 corresponds to a dense layer, each second layer 212-1, 212-2 corresponds to a rectified linear unit (ReLU), and each third layer 214-1, 214-2 corresponds to a batch normalization layer. In another example, each first layer 210-1, 210-2 corresponds to a dense layer, each second layer 212-1, 212-2 corresponds to a dropout layer, and each third layer 214-1, 214-2 corresponds to a rectified linear unit (ReLU). A third stage 202-3 includes a dense layer 216 and an activation layer 218. In one nonlimiting example, the activation layer 218 may correspond to a sigmoid activation function. However, this disclosure is not limited in this regard. In one nonlimiting example, the input vector 120 may have dimension 24, the first dense layers 210-1, 210-2, may have dimension 64, and dense layer 216 may have dimension 1. However, this disclosure is not limited in this regard. For example, the input vector 120 may have dimension greater than or less than 24.

Turning again to FIG. 1, initially, decision network 102 (i.e., group ANN 124 and/or individual ANN 126) may be trained by decision module 106 and/or training module 108 based, at least in part, on training data. Training data may be included in input data 105 received by decision module 106. Training data may include, e.g., group training data, individual training data, human decision-maker characteristic data, etc. Training data may be configured as training data pairs that each include a training input vector, and corresponding training group output or corresponding training individual output. Each training input vector may include a plurality of scenario parameters. The scenario parameters are configured to provide a basis for a decision-maker's moral decision and each moral decision corresponds to a training output. Each training output (group or individual) may thus correspond to a group decision-maker decision or an individual decision maker decision. It may be appreciated that group decision-maker decisions may correspond to a multivariate distribution.

Each scenario parameter included in the training input vector may have been selected from a group of possible scenario parameters, related to the ethical dilemma to be modeled. In an embodiment, the group of possible scenario parameters may correspond to characters and character status of the Moral Experiment. In one nonlimiting example, the group of scenario parameters may include, but is not limited to, sex (e.g., male, female), age group (e.g., young, old, infancy), pregnant, fat, fit, working (e.g., business person), medical (e.g., doctor), homeless, criminal, human, non-human (e.g., cat, dog), passenger, law-abiding, law violating, and/or combinations thereof (e.g., young male, young female, old male, old female, etc.), and number of characters in each category.

Continuing with this embodiment, a corresponding moral decision (i.e., training output, decision output) may be related to selecting between two groups of characters in the specific scenario. In other words, the moral decision may be binary, e.g., intervene versus (vs.) don't intervene (i.e., not intervene); swerve vs. don't swerve; select option A vs. select option B.

In another embodiment, the group of possible scenario parameters may be related to patient health care. Continuing with this embodiment, in one example, each scenario parameter included in a selected input vector may be related to a selected patient. In another example, the scenario parameters may be related to a group of patients who may have at least one common patient attribute. The group of possible scenario parameters and/or patient attribute may include, but is not limited to, a sex parameter corresponding to the patient (e.g., gender identity/expression, birth gender), patient age (e.g., actual age or age range), ethnicity, health status, disability status, presence or absence of a selected health issue (e.g., illness and/or disease), socioeconomic status, cost of therapy, disease diagnosis, confidence level associated with diagnosis, risk tolerance, historic imaging radiation exposure (e.g., recent and/or repeated x-ray and/or computed tomography (CT) scan), etc.

Continuing with this embodiment, a corresponding moral decision (i.e., training output, decision output) may be related to selecting between two health care-related options. For example, the moral decision may include selecting between therapeutic option A vs. therapeutic option B. In another example, the moral decision may be related to selecting between imaging options to help support a diagnosis or making the diagnosis.

It may be appreciated that the particular moral decision is related to the particular scenario parameters and corresponding input vectors.

In an embodiment, training operations may begin with receiving input data 105, that includes group training data, e.g., a plurality of group training pairs (i.e., group input vectors and corresponding training group output). The group training data may be received by decision module 106 and stored in data store 118. Group ANN 124 may then be trained, e.g., by training module 108, using the group training data. Training group ANN 124 may include adjusting group ANN 124 network parameters (and possibly configuration) based, at least in part, on a comparison of an estimated group output 125 and the corresponding training group output for a selected training input vector. The comparison may generally include evaluating a loss function, related to a difference between the estimated group output 125 and the training group output. In one nonlimiting example, the loss function may correspond to a binary cross entropy function. However, this disclosure is not limited in this regard. When training group ANN 124 is complete, the trained group ANN 124 network parameters (and possibly configuration data) may be stored in data store 118 or maintained in group ANN 124.

Training operations may then continue with training the individual ANN 126. In an embodiment, the group ANN parameters and configuration that resulted from training group ANN 124 may be held fixed during training the individual ANN 126. The individual ANN 126 training operations may begin with receiving input data 105, that includes individual training data, e.g., a plurality of individual training pairs (i.e., individual input vectors and corresponding training individual output and/or individual input vectors and corresponding training decision output). The individual training data may be received by decision module 106 and stored in data store 118. Individual ANN 126 may then be trained, e.g., by training module 108, using the individual training data.

In one embodiment, the individual ANN 126 may be trained using discriminator 109 in a WGAN framework. The WGAN framework is configured to accommodate possibly limited individual training data. In other words, group training data may contain more training data pairs given that the group training data includes training data pairs from a plurality of individuals, while individual training data is configured to include training data pairs from a selected individual.

In one example, training individual ANN 126 may include adjusting individual ANN 126 network parameters (and possibly configuration) based, at least in part, on a comparison of an estimated individual output 127 and the corresponding training individual output for a selected training input vector. In another example, training individual ANN 126 may include adjusting individual ANN 126 network parameters and possibly fusion block parameters based, at least in part, on a comparison of an estimated decision output 122 and the corresponding training decision output for a selected training input vector.

Thus, in an embodiment, there is provided a method for training a decision network for individual moral decision-making. The method includes adjusting, by a training module, at least one group network parameter of a group ANN based, at least in part, on group training data. The group training data includes a plurality of training group data pairs. Each training group data pair includes a training group input vector and a corresponding group output. Each training group input vector includes a plurality of scenario parameters. The method further includes adjusting, by the training module, at least one individual network parameter of an individual ANN based, at least in part, on individual training data. The individual training data includes a plurality of individual training data pairs. Each training individual data pair includes a training individual input vector and a corresponding individual output. Each training individual input vector includes a plurality of scenario parameters. The group network parameters are fixed during the training of the individual ANN.

Thus, decision network 102 may be trained, using group training data and individual training data. The group ANN 124 be trained first and the group ANN network parameters may be frozen. The individual ANN 126 may then be trained and possibly the fusion block adjusted, to achieve training the decision network. For example, the training module 108 may be configured to adjust a fusion block parameter associated with fusion block 128. The fusion block parameters may be related to concatenation, addition and multiplication functions of the fusion block 128. The trained decision network may then be applied to provide a moral decision, i.e., decision output, based, at least in part, on a selected input vector, as described herein.

After training, decision system 100, e.g., decision module 106, may be configured to receive input data 105 that includes a selected input vector, e.g., input vector 120, for which a decision output is to be provided. The selected input vector 120 may then be provided to decision network 102. Decision network 102 may then produce a corresponding decision output, e.g., decision output 122, based, at least in part, on the received selected input vector 120, and using the trained group ANN 124, trained individual ANN 126 and fusion block 128. The decision output may then correspond to a moral decision, related to the received training data.

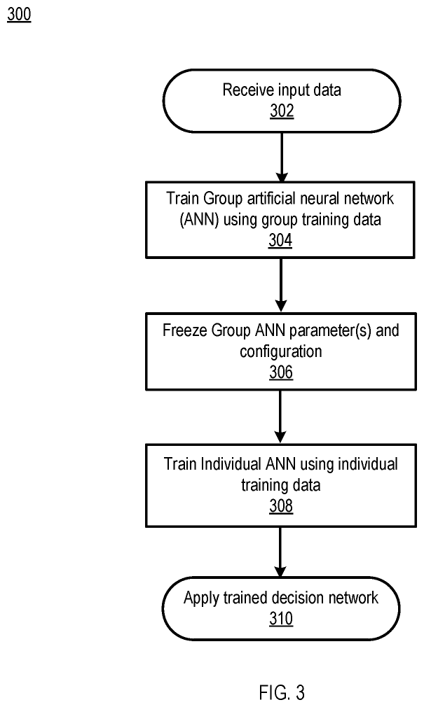

FIG. 3 is a flowchart 300 of operations for moral decision-making, according to various embodiments of the present disclosure. In particular, the flowchart 300 illustrates training a decision network (that includes a group ANN and an individual ANN, as described herein) and then applying the trained decision network. The operations may be performed, for example, by the decision system 100 (e.g., decision network 102, decision module 106, and/or training module 108) of FIG. 1.

Operations of this embodiment may begin with receiving input data at operation 302. Operation 304 includes training group ANN using group training data. Operation 306 includes freezing group ANN parameters and configuration. An individual ANN may be trained, using individual training data, at operation 308. The trained system may then be applied at operation 310.

Thus, a decision network, including a group ANN and an individual ANN may be trained and then applied to an input vector to generate a moral decision.

Thus, decision network that includes a group ANN and an individual ANN may correspond to a deep learning model for learning the abstract moral values of an individual. By broadly learning the moral values of a cultural group, and then observing a few decisions of an individual belonging to this group, a decision network may be configured predict the moral decisions of the individual in new scenarios. An accurate deep learning model for moral decision making may then be useful for embedding morality in future AI systems.

It may be appreciated that a deep learning based model (i.e., decision network) may be effective in learning both moral values and making moral decisions in a data-driven fashion. A decision network model may be configured to adapt to a plurality of training examples, without assumptions regarding the distribution of moral values in a population, or the decision process as a function of moral values. Given sufficient training data, a deep learning approach, according to the present disclosure, may provide benefits, since underlying moral value distributions and decision processes are generally unknown.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A decision network for moral decision-making, the decision network comprising:
a trained group artificial neural network (ANN) configured to receive a selected input vector and to produce an estimated group output based, at least in part, on the selected input vector, the trained group ANN trained based, at least in part, on group training data comprising a plurality of group input vectors and corresponding training group outputs, each group input vector comprising a plurality of scenario parameters;
a trained individual ANN configured to receive the selected input vector and to produce an estimated individual output based, at least in part, on the selected input vector, the trained individual ANN trained after the trained group ANN is trained, the trained individual ANN trained based, at least in part, on individual training data comprising a plurality of individual input vectors and corresponding training individual outputs, each individual input vector comprising the plurality of scenario parameters, and each training individual output corresponding to a same individual; and
a fusion block coupled to the trained group ANN and the trained individual ANN, and configured to receive the estimated group output and the estimated individual output, and to produce a decision output based, at least in part, on the estimated group output and based, at least in part, on the estimated individual output.

2. The decision network according to claim 1, wherein each ANN corresponds to a dense encoder network.

3. The decision network according to claim 1, wherein each ANN comprises a first stage, a second stage and a third stage, the first stage and the second stage each comprising a respective first layer, a respective second layer, and a respective third layer, each first layer corresponding to a dense layer, each second layer corresponding to a rectified linear unit (ReLU), and each third layer corresponding to a batch normalization layer, the third stage comprising a dense layer, and an activation layer.

4. The decision network according to claim 1, wherein each ANN comprises a first stage, a second stage and a third stage, the first stage and the second stage each comprising a respective first layer, a respective second layer, and a respective third layer, each first layer corresponding to a dense layer, each second layer corresponding to a dropout layer, and each third layer corresponding to a rectified linear unit (ReLU), the third stage comprising a dense layer, and an activation layer.

5. The decision network according to claim 1, wherein each scenario parameter is selected from the group comprising a plurality of categories comprising sex, age group, pregnant, fat, fit, working, medical, homeless, criminal, human, non-human, passenger, law-abiding, law violating, and/or a combination thereof, and number of characters in each category.

6. The decision network of claim 5, wherein the decision output is selected from the group comprising intervene or not intervene.

7. A method for training a decision network for individual moral decision-making, the method comprising:
adjusting, by a training module, at least one group network parameter of a group artificial neural network (ANN) based, at least in part, on group training data, the group training data comprising a plurality of training group data pairs, each training group data pair comprising a training group input vector and a corresponding group output, each training group input vector comprising a plurality of scenario parameters; and
adjusting, by the training module, at least one individual network parameter of an individual ANN based, at least in part, on individual training data, the individual training data comprising a plurality of individual training data pairs, each training individual data pair comprising a training individual input vector and a corresponding individual output, each training individual input vector comprising a plurality of scenario parameters, the group network parameters fixed during the training of the individual ANN.

8. The method of claim 7, further comprising adjusting, by the training module, a fusion block parameter, the fusion block configured to receive an estimated group output from the group ANN and an estimated individual output from the individual ANN, and to produce a decision output, the fusion block coupled to the group ANN and the individual ANN.

9. The method of claim 7, wherein each ANN corresponds to a dense encoder network.

10. The method of claim 7, wherein each ANN comprises a first stage, a second stage and a third stage, the first stage and the second stage each comprising a respective first layer, a respective second layer, and a respective third layer, each first layer corresponding to a dense layer, each second layer corresponding to a rectified linear unit (ReLU), and each third layer corresponding to a batch normalization layer, the third stage comprising a dense layer, and an activation layer.

11. The method of claim 7, wherein each ANN comprises a first stage, a second stage and a third stage, the first stage and the second stage each comprising a respective first layer, a respective second layer, and a respective third layer, each first layer corresponding to a dense layer, each second layer corresponding to a dropout layer, and each third layer corresponding to a rectified linear unit (ReLU), the third stage comprising a dense layer, and an activation layer.

12. The method of claim 7, wherein each scenario parameter is selected from the group comprising a plurality of categories comprising sex, age group, pregnant, fat, fit, working, medical, homeless, criminal, human, non-human, passenger, law-abiding, law violating, and/or a combination thereof, and number of characters in each category.

13. The method of claim 12, wherein the decision output is selected from the group comprising intervene or not intervene.

14. A computer readable storage device having stored thereon instructions that when executed by one or more processors result in the following operations comprising: the method according to claim 7.

15. A decision system for moral decision-making, the decision system comprising:
a computing device comprising a processor, a memory, an input/output circuitry, and a data store; and
a decision network for moral decision-making, the decision network comprising:
a trained group artificial neural network (ANN) configured to receive a selected input vector and to produce an estimated group output based, at least in part, on the selected input vector, the trained group ANN trained based, at least in part, on group training data comprising a plurality of group input vectors and corresponding training group outputs, each group input vector comprising a plurality of scenario parameters;
a trained individual ANN configured to receive the selected input vector and to produce an estimated individual output based, at least in part, on the selected input vector, the trained individual ANN trained after the trained group ANN is trained, the trained individual ANN trained based, at least in part, on individual training data comprising a plurality of individual input vectors and corresponding training individual outputs, each individual input vector comprising the plurality of scenario parameters, and each training individual output corresponding to a same individual; and
a fusion block coupled to the trained group ANN and the trained individual ANN, and configured to receive the estimated group output and the estimated individual output, and to produce a decision output based, at least in part, on the estimated group output and based, at least in part, on the estimated individual output.

16. The decision system of claim 15, wherein each ANN corresponds to a dense encoder network.

17. The decision system of claim 15, wherein each ANN comprises a first stage, a second stage and a third stage, the first stage and the second stage each comprising a respective first layer, a respective second layer, and a respective third layer, each first layer corresponding to a dense layer, each second layer corresponding to a rectified linear unit (ReLU), and each third layer corresponding to a batch normalization layer, the third stage comprising a dense layer, and an activation layer.

18. The decision system of claim 15, wherein each ANN comprises a first stage, a second stage and a third stage, the first stage and the second stage each comprising a respective first layer, a respective second layer, and a respective third layer, each first layer corresponding to a dense layer, each second layer corresponding to a dropout layer, and each third layer corresponding to a rectified linear unit (ReLU), the third stage comprising a dense layer, and an activation layer.

19. The decision system according to claim 15, wherein each scenario parameter is selected from the group comprising a plurality of categories comprising sex, age group, pregnant, fat, fit, working, medical, homeless, criminal, human, non-human, passenger, law-abiding, law violating, and/or a combination thereof, and number of characters in each category; and the decision output is selected from the group comprising intervene or not intervene.

20. The decision system according to claim 15, further comprising a decision module configured to receive input data comprising the selected input vector, and to manage operation of the decision network.
